(19) United States
(12) Patent Application Publication
(10) Pub. No.: US 2025/0298965 A1
(43) Pub. Date: Sep. 25, 2025

(54) SYSTEM AND METHOD FOR PERFORMING ANALYSIS OF DOCUMENTS

(71) Applicant: Newgen Software Technologies Limited, Chennai (IN)

(72) Inventors: Robin J. SYLVESTER, Chennai (IN); T.T. ANIRUDH, Chennai (IN)

(21) Appl. No.: 19/085,468

(22) Filed: Mar. 20, 2025

(30) Foreign Application Priority Data
Mar. 22, 2024 (IN) 202441022070

(51) Int. Cl. G06F 40/166; G06F 16/34; G06F 16/93; G06F 40/205

(52) U.S. Cl. CPC G06F 40/166; G06F 16/345; G06F 16/93; G06F 40/205

(57) ABSTRACT

The invention relates to a system 100 and method for performing analysis of documents. The method includes obtaining a set of user-specific context parameters and a text document from a user device 150. The user-specific parameters relate to one or more queries on a set of information provided within the text document. Further, the method includes determining the set of information from the text document based on the set of user-specific context parameters. Further, the method includes extracting the set of information into a plurality of fields of a predefined data structure. Further, the method includes generating a text summary for the set of information on the user device 150 along with the predefined data structure.

### PRIORITY STATEMENT

The present application claims priority under 35 U.S.C. § 119 to Indian provisional patent application number 202441022070 filed 22 Mar. 2024 the entire contents of which are hereby incorporated herein by reference.

### BACKGROUND

The invention generally relates to the field of document inspecting system and method, and more particularly, to a system and a method for performing analysis of documents.

Generally, various existing methods for performing manual visual inspection in documents (e.g., invoice, medical receipt, or the like) largely depend on a well-trained and disciplined workforce. Reduction of human errors in the document inspection has recently become a significant focus across various industries (such as pharmaceutical manufacturing industry, finance industry or the like). Where humans are involved, the potential for human-related errors naturally exists. However, these errors can be greatly minimized by ensuring that the right technical skills and personality traits are paired with effective training and qualifications. Nowhere is this more evident than in manual visual inspection, where attention to detail and knowing which details to focus on are key factors for achieving successful inspection outcomes.

In an example, the documents containing details such as invoices, cheques might be tedious to go through with manual effort for inspection and gathering information. Hence, the manual inspection are also prone to human errors and it is also time consuming.

Hence, there is a need for a method and a system for providing analysis of documents by using a data driven model (e.g., machine learning (ML) model, artificial intelligence (AI) model or the like) in an accurate and time effective manner.

### SUMMARY

The following summary is illustrative only and is not intended to be in any way limiting. In addition to the illustrative aspects, example embodiments, and features described, further aspects, example embodiments, and features will become apparent by reference to the drawings and the following detailed description.

Briefly, according to an example embodiment, a system and a method for providing analysis of documents is provided. The system includes a user interface, an interpretation module, an extraction module and a database. The user interface is configured to obtain a set of user-specific context parameters and a text document from a user device. In an embodiment, the text document is in one of an image format, and a textual format. The user-specific parameters relate to one or more queries on a set of information provided within the text document. The interpretation module is configured to determine the set of information from the text document based on the set of user-specific context parameters. Further, the interpretation module is configured to generate a text summary for the set of information. The interpretation module is further configured to convert the text document from an image format to a textual format and parse the text document to obtain a plurality of sets of information. The extraction module is configured to extract the set of information into a plurality of fields of a predefined data structure. The user interface is configured to render the text summary for the set of information along with the predefined data structure on a display of the user device. In an embodiment, the predefined data structure includes one of a comma-separated values (.csv) file, and a tabular format in a textual document. The database is configured to store the predefined structure.

Briefly, according to another example embodiment, a method for providing summaries of documents. The method includes obtaining a set of user-specific context parameters and a text document from a user device. The user-specific parameters relate to one or more queries on a set of information provided within the text document. Further, the method includes determining the set of information from the text document based on the set of user-specific context parameters. Further, the method includes extracting the set of information into a plurality of fields of a predefined data structure. Further, the method includes generating a text summary for the set of information on the user device along with the predefined data structure. Further, the method includes storing the predefined structure in a database.

### BRIEF DESCRIPTION OF THE FIGURES

These and other features, aspects, and advantages of the example embodiments will become better understood when the following detailed description is read with reference to the accompanying drawings in which like characters represent like parts throughout the drawings, wherein:

FIG. 1 is a block diagram of a user device for providing summaries of documents in a system, according to some aspects of the present description;

FIG. 2 illustrates a flow diagram of a method for providing summaries of the documents, according to some aspects of the present description;

FIG. 3 is an example scenario in which the system providing summaries of the documents is explained, according to some aspects of the present description;

FIG. 4 is an example embodiment in which the user device provides summaries of the documents, according to some aspects of the present description;

FIG. 5 is an example embodiment in which the user device provides summaries of the documents, according to some aspects of the present description; and

FIG. 6 is a block diagram of an embodiment of a computing device in which the modules of the system providing summaries of documents, described herein, are implemented.

### DETAILED DESCRIPTION OF EXAMPLE EMBODIMENTS

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in a hardware, firmware, software, or a combination thereof.

Various example embodiments will now be described more fully with reference to the accompanying drawings in which only some example embodiments are shown. Specific structural and functional details disclosed herein are merely representative for purposes of describing example embodiments. Example embodiments, however, may be embodied in many alternate forms and should not be construed as limited to only the example embodiments set forth herein. On the contrary, example embodiments are to cover all modifications, equivalents, and alternatives thereof.

Accordingly, while example embodiments are capable of various modifications and alternative forms, example embodiments are shown by way of example in the drawings and will herein be described in detail. It should be understood, however, that there is no intent to limit example embodiments to the particular forms disclosed. On the contrary, example embodiments are to cover all modifications, equivalents, and alternatives thereof. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figures. It should also be noted that in some alternative implementations, the functions/acts/steps noted may occur out of the order noted in the figures. For example, two figures shown in succession may, in fact, be executed substantially concurrently or may sometimes be executed in the reverse order, depending upon the functionality/acts involved.

Specific structural and functional details disclosed herein are merely representative for purposes of describing example embodiments. Inventive concepts may, however, be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or,” includes any and all combinations of one or more of the associated listed items. The phrase “at least one of” has the same meaning as “and/or”.

Further, although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or a section. Thus, a first element, component, region, layer, or section discussed below could be termed a second element, component, region, layer, or section without departing from the scope of example embodiments.

Spatial and functional relationships between elements (for example, between modules) are described using various terms, including “connected,” “engaged,” “interfaced,” and “coupled.” Unless explicitly described as being “direct,” when a relationship between first and second elements is described in the description below, that relationship encompasses a direct relationship where no other intervening elements are present between the first and second elements, and also an indirect relationship where one or more intervening elements are present (either spatially or functionally) between the first and second elements. In contrast, when an element is referred to as being “directly” connected, engaged, interfaced, or coupled to another element, there are no intervening elements present. Other words used to describe the relationship between elements should be interpreted in a like fashion (e.g., “between”, versus “directly between”, “adjacent”, versus “directly adjacent” etc.).

The terminology used herein is for the purpose of describing particular example embodiments only and is not intended to be limiting. Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

Unless specifically stated otherwise, or as is apparent from the description, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

The systems described herein, may be realized by hardware elements, software elements and/or combinations thereof. For example, the devices and components illustrated in the example embodiments of inventive concepts may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A central processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the central processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively control the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected via networks and may be stored or executed in a dispersion manner. Software and data may be recorded in one or more computer readable storage media.

Example embodiments of the present invention provide systems and methods for providing summaries of documents.

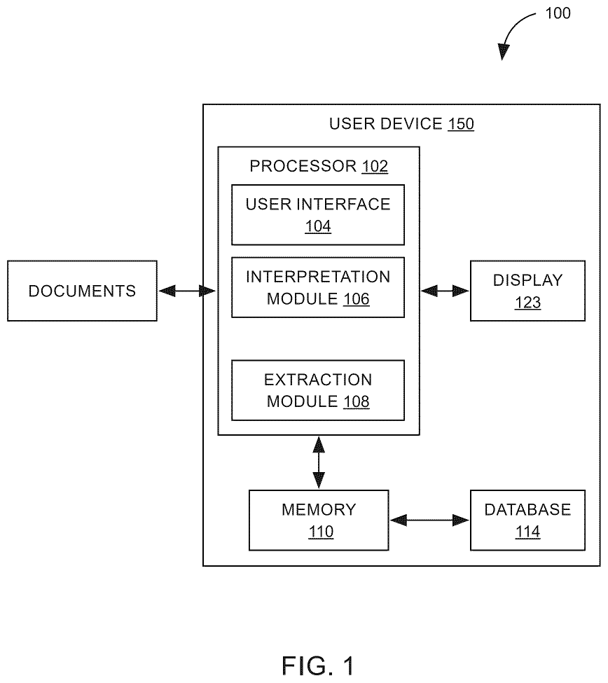

FIG. 1 is a block diagram of a user device 150 for providing summaries of documents in a system 100, according to some aspects of the present description. The user device 150 may include, but are not limited to, a handheld wireless communication device (e.g., a mobile phone, a smart phone, a phablet device, and so on), a wearable computer device (e.g., a head-mounted display computer device, a head-mounted camera device, a wristwatch computer device, and so on), a laptop computer, a tablet computer, or another type of portable computer, a media playing device, a portable gaming system, and/or any other type of computer device with wireless communication.

The system 100 includes a user device 150. The user device 150 includes a processor 102, a memory 110, a display 112, and a database 114. The processor 102 is coupled with the memory 110, the display 112, and the database 114. The processor 102 includes a user interface 104, an interpretation module 106, and an extraction module 108. The user interface 104, the interpretation module 106, and the extraction module 108 communicate with each other.

The processor 102 may be implemented as one or more microprocessors, microcomputers, microcontrollers, digital signal processors, central processing units, state machines, logic circuitries, single board computers, and/or any devices that manipulate signals based on operational instructions. As per the illustrated embodiment, the user device 150 includes one processor 102. However, it is to be noted that the user device 150 may include multiple processors as per the requirement and without deviating from the scope of the present disclosure.

Further, the processor 102, in an embodiment, may be implemented as a combination of hardware and programming (for example, programmable instructions) to implement one or more functionalities of the processor 102. In the examples described herein, such combinations of hardware and programming may be implemented in several different ways. For example, the programming for the processor 102 may be processor-executable instructions stored on a non-transitory machine-readable storage medium and the hardware for the processor 102 may comprise a processing resource (for example, one or more processors), to execute such instructions. In the present examples, the memory 104 may store instructions that, when executed by the processing resource, implement the processor 102. In such examples, the user device 150 may comprise the memory 110 storing the instructions and the processing resource to execute the instructions, or the memory 110 may be separate but accessible to the user device 100 and the processing resource. In other examples, the processor 102 may be implemented by electronic circuitry.

The memory 110 stores one or more processor-executable instructions, and the processor 102 is communicatively coupled to the memory 110 to execute one or more processor-executable routines. The memory 110 may be configured to store one or more computer-readable instructions or routines in a non-transitory computer-readable storage medium, which may be fetched and executed to create or share data packets over a network service. The memory 110 may include any non-transitory storage device including, for example, volatile memory such as RAM, or non-volatile memory such as disk memory, EPROMs, FLASH memory, unalterable memory, and the like. The memory 110 is coupled with a database 114. The display 112 can may be a monitor that provides an output of the user devices such as displaying details of the document processing.

The user interface 104 may include functionality similar to at least a portion of functionality implemented by one or more computer system interfaces such as those described herein and/or generally known to one having ordinary skill in the art. The user interface 104 may be rendered on the display 112, implemented using LCD display technology, OLED display technology, and/or other types of conventional display technology. Further the user interface 104 may include, but not limited to, keyboard, buttons, scroll wheels, cursors, touchscreen sensors, audio command interfaces, magnetic strip reader, optical scanner, etc.

In an embodiment, the user interface 104 obtains the set of user-specific context parameters and the text document from the user device 150. In an embodiment, the text document is in one of an image format, and a textual format. The user-specific parameters relate to one or more queries on a set of information provided within the text document. Based on the set of user-specific context parameters, the interpretation module 106 determines the set of information from the text document. Further, the interpretation module 106 generates the text summary for the set of information. The interpretation module 106 converts the text document from the image format to the textual format and parse the text document to obtain the plurality of sets of information using a machine learning (ML) model or an artificial intelligence (AI) model (e.g., LLM model or the like). The extraction module 108 extracts the set of information into a plurality of fields of a predefined data structure. The user interface 104 renders the text summary for the set of information along with the predefined data structure on the display 112 of the user device 150. In an embodiment, the predefined data structure includes one of a comma-separated values (.csv) file, and a tabular format in a textual document. The database 114 is configured to store the predefined data structure.

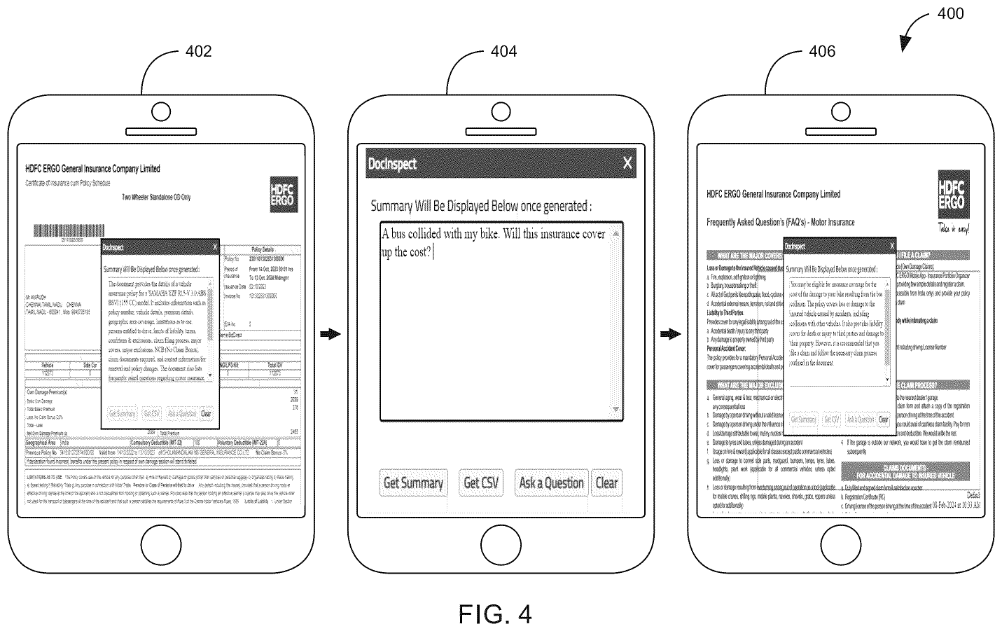

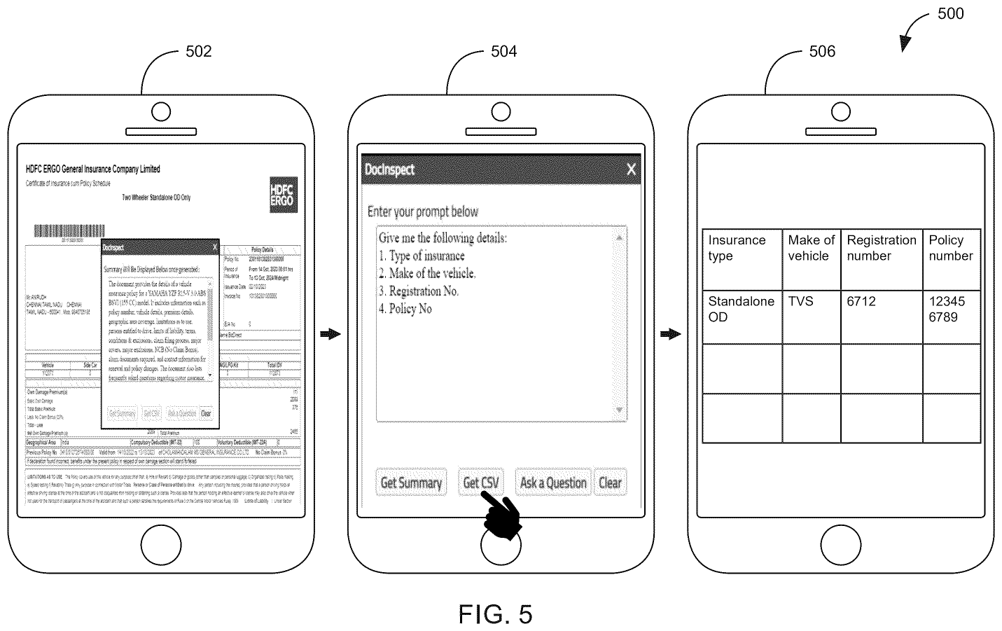

In an example, the user device 100 providing summaries of the documents is explained in FIG. 4 and FIG. 5.

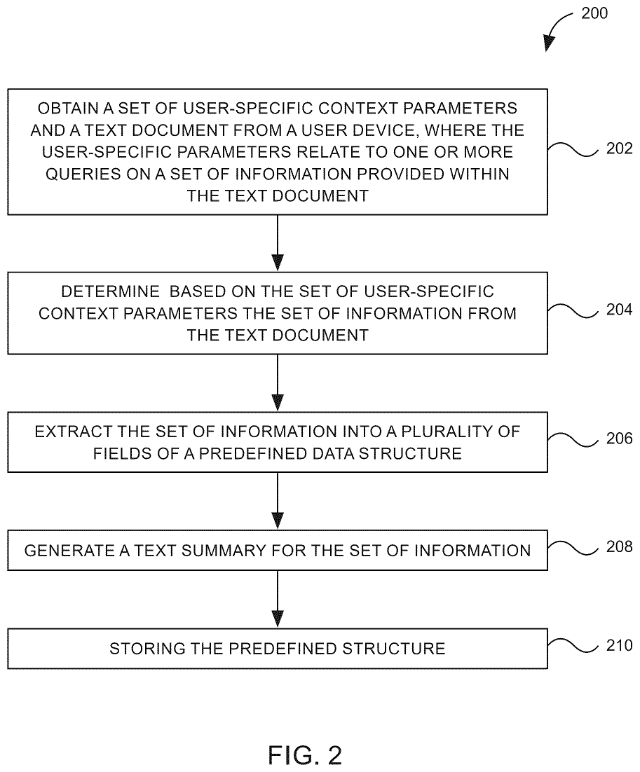

FIG. 2 illustrates a flow diagram 200 of a method for providing summaries of the documents, according to some aspects of the present description.

At step 202, the method includes obtaining the set of user-specific context parameters and the text document from the user device 150. The user-specific parameters relate to one or more queries on the set of information provided within the text document. At step 204, the method includes determining the set of information from the text document based on the set of user-specific context parameters. At step 206, the method includes extracting the set of information into the plurality of fields of the predefined data structure.

At step 208, the method includes generating the text summary for the set of information on the user device 150 along with the predefined data structure. At step 210, the method includes storing the predefined structure in the database 114.

By using the proposed method, the generative AI technology, more specifically in this case LLMs (Large Language Model) can assist in parsing seemingly complex document data and present the relevant data required by the user in efficient and user-friendly manner so as to reduce manual effort, time and less chance of human errors as well. This includes summarization, fetching of specific detail such as invoice number or to get a range of details in a csv/table format for database storage (for example).

The proposed method acts as a valuable virtual assistant to the user by offering the capability of summarization, specific data extraction and interpretation out of a document with minimal effort and time. The proposed method will prove to be a valuable assistant to the document viewer by providing the client the ability to not just view the document but also interact with it in one of the most user friendly ways possible.

The various actions, acts, blocks, steps, or the like in the flow diagram 200 may be performed in the order presented, in a different order or simultaneously. Further, in some embodiments, some of the actions, acts, blocks, steps, or the like may be omitted, added, modified, skipped, or the like without departing from the scope of the invention.

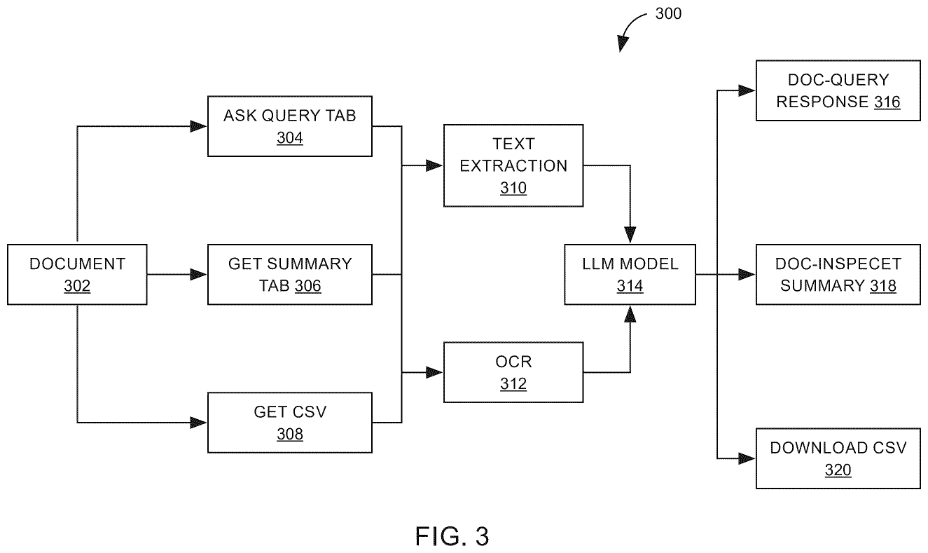

FIG. 3 is an example scenario in which the system 300 providing summaries of the documents is explained, according to some aspects of the present description. At 302, the document is received at the user device 150. Based on the proposed method, the user interface 104 enables an ASK QUERY tab 304, a GET SUMMARY TAB 306, and a GET CSV TAB 308. Based on the user input received on the any one of the tab (e.g., ASK QUERY tab 304, GET SUMMARY TAB 306, and the GET CSV TAB 308), at 310 and 312, the text data and the image can be extracted from the document through the OCR and then be passed to the LLM model 314. After processing, the LLM model 314 will parse the content and give the appropriate response back to the user based on the prompt fetching the requested information such as summary/specific detail as shown in a DOC-QUERY RESPONSE 316, a DOC-INSPECET SUMMARY 318, and a DOWNLOAD CSV 320. There is also an option to store the information in the csv format after fetching specific details and tabulating it based on the prompt given to the user. The more detailed example is explained in FIG. 4 and FIG. 5.

FIG. 4 and FIG. 5 are example scenarios 400 and 500 in which the user device 150 provides summaries of the documents, according to some aspects of the present description.

As shown in FIG. 4, at 402, the document is provided and inspected at the user device 150. After inspecting the document, at 404, the user asking get summary for the insurance coverup cost in the provided documents (e.g., insurance related documents or the like) while meeting an accident. Based on the user input, at 406, the user device 150 provides the response as the insurance coverup cost while meeting accident.

As shown in FIG. 5, at 502, the document is provided and inspected at the user device 150. After inspecting the document, at 504, the user asking get summary for various details related to the insurance type, a police number, a vehicle registration number, and make of vehicle in the provided documents (e.g., insurance related documents or the like). Based on the user input, at 506, the user device 150 provides the response to the query of the insurance type, a police number, a vehicle registration number, and make of vehicle.

By using the proposed method, the generative AI technology, more specifically in this case LLMs (Large Language Model) can assist in parsing seemingly complex document data and present the relevant data required by the user in efficient and user-friendly manner so as to reduce manual effort, time and less chance of human errors as well. This includes summarization, fetching of specific detail such as invoice number or to get a range of details in a csv/table format for database storage. The proposed method will prove to be a valuable assistant to the document viewer by providing the client the ability to not just view the document but also interact with it in one of the most user friendly ways possible.

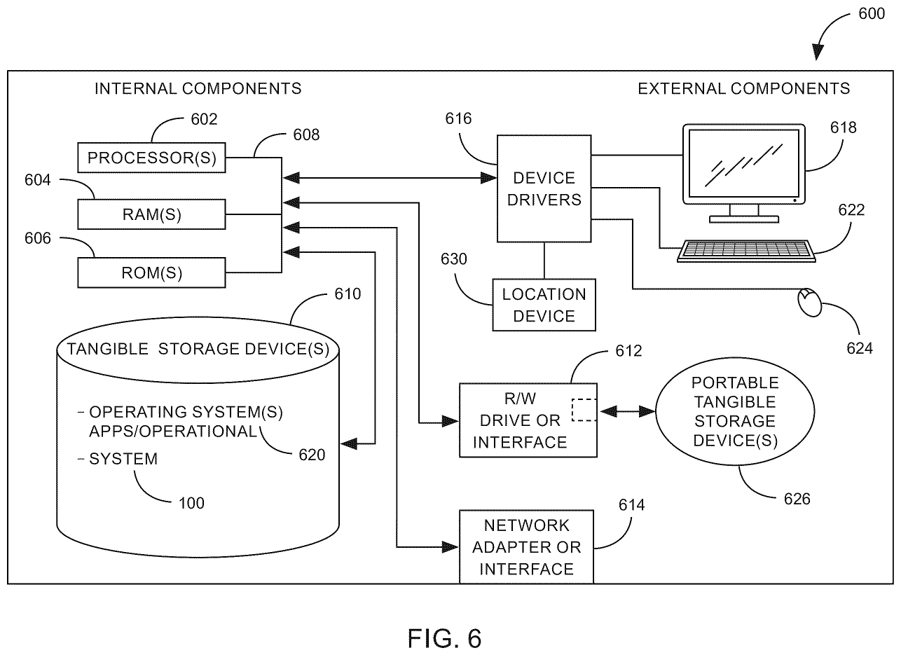

FIG. 6 is a block diagram of an embodiment of a computing device 600 in which the modules of the system 100 providing summaries of documents, described herein, are implemented. One example of the computing device 600 is described below in FIG. 6. The computing device 600 includes one or more processor(s) 602, one or more computer-readable RAMs 604 and one or more computer-readable ROMs 606 on one or more buses 608. Further, the computing device 600 includes a tangible storage device 610 that may be used to execute operating systems 620 and the system 100. The various modules of the system 100 may be stored in the tangible storage device 610. Both, the operating systems 620 and the system 100 are executed by the one or more processor(s) 602 via one or more respective RAMs 604 (which typically include cache memory). The execution of the operating systems 620 and/or the system 100 by the one or more processor(s) 602, configures the one or more processor(s) 602 as a special purpose processor configured to carry out the functionalities of the operation systems 620 and/or the system 100 as described above.

Examples of the tangible storage device 610 include semiconductor storage devices such as ROM, EPROM, flash memory or any other computer-readable tangible storage device that may store a computer program and digital information.

The computing device 600 also includes a R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless Wi-Fi interface cards, or 3G or 4G wireless interface cards or other wired or wireless communication links are also included in computing device.

In one example embodiment, the system 100 may be stored in the tangible storage device 610 and may be downloaded from an external computer via a network (for example, the Internet, a local area network or other, wide area network) and network adapter or interface 612.

The computing device 600 further includes device drivers 616 to interface with input and output devices. The input and output devices may include a computer display monitor 618, a keyboard 622, a keypad, a touch screen, a computer mouse 624, and/or some other suitable input device.

In this description, including the definitions mentioned earlier, the term ‘module’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware. The term code, as used above, may include software, firmware, and/or microcode, and may refer to programs, routines, functions, classes, data structures, and/or objects.

Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above. Shared memory hardware encompasses a single memory device that stores some or all code from multiple modules. Group memory hardware encompasses a memory device that, in combination with other memory devices, stores some or all code from one or more modules.

In some embodiments, the module may include one or more interface circuits. In some examples, the interface circuits may include wired or wireless interfaces that are connected to a local area network (LAN), the Internet, a wide area network (WAN), or combinations thereof. The functionality of any given module of the present description may be distributed among multiple modules that are connected via interface circuits. For example, multiple modules may allow load balancing. In a further example, a server (also known as remote, or cloud) module may accomplish some functionality on behalf of a client module.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

While only certain features of several embodiments have been illustrated, and described herein, many modifications and changes will occur to those skilled in the art. It is, therefore, to be understood that the appended claims are intended to cover all such modifications and changes as fall within the true spirit of inventive concepts.

The aforementioned description is merely illustrative in nature and is in no way intended to limit the disclosure, its application, or uses. The broad teachings of the disclosure may be implemented in a variety of forms. Therefore, while this disclosure includes particular examples, the true scope of the disclosure should not be so limited since other modifications will become apparent upon a study of the drawings, the specification. It should be understood that one or more steps within a method may be executed in different order (or concurrently) without altering the principles of the present disclosure. Further, although each of the example embodiments is described above as having certain features, any one or more of those features described with respect to any example embodiment of the disclosure may be implemented in and/or combined with features of any of the other embodiments, even if that combination is not explicitly described. In other words, the described example embodiments are not mutually exclusive, and permutations of one or more example embodiments with one another remain within the scope of this disclosure.

The example embodiment or each example embodiment should not be understood as a limiting/restrictive of inventive concepts. Rather, numerous variations and modifications are possible in the context of the present disclosure, in particular those variants and combinations which may be inferred by the person skilled in the art with regard to achieving the object for example by combination or modification of individual features or elements or method steps that are described in connection with the general or specific part of the description and/or the drawings, and, by way of combinable features, lead to a new subject matter or to new method steps or sequences of method steps, including insofar as they concern production, testing and operating methods. Further, elements and/or features of different example embodiments may be combined with each other and/or substituted for each other within the scope of this disclosure.

Still further, any one of the above-described and other example features of example embodiments may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

In this application, including the definitions below, the term ‘module’ or the term ‘controller’ may be replaced with the term ‘circuit.’ The term ‘module’ may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Further, at least one example embodiment relates to a non-transitory computer-readable storage medium comprising electronically readable control information (e.g., computer-readable instructions) stored thereon, configured such that when the storage medium is used in a controller of a magnetic resonance device, at least one example embodiment of the method is carried out.

Even further, any of the aforementioned methods may be embodied in the form of a program. The program may be stored on a non-transitory computer readable medium, such that when run on a computer device (e.g., a processor), cause the computer-device to perform any one of the aforementioned methods. Thus, the non-transitory, tangible computer readable medium is adapted to store information and is adapted to interact with a data processing facility or computer device to execute the program of any of the above-mentioned embodiments and/or to perform the method of any of the above-mentioned embodiments.

The computer readable medium or storage medium may be a built-in medium installed inside a computer device main body or a removable medium arranged so that it may be separated from the computer device main body. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave), the term computer-readable medium is therefore considered tangible and non-transitory. Non-limiting examples of the non-transitory computer-readable medium include, but are not limited to, rewriteable non-volatile memory devices (including, for example flash memory devices, erasable programmable read-only memory devices, or a mask read-only memory devices), volatile memory devices (including, for example static random access memory devices or a dynamic random access memory devices), magnetic storage media (including, for example an analog or digital magnetic tape or a hard disk drive), and optical storage media (including, for example a CD, a DVD, or a Blu-ray Disc). Examples of the media with a built-in rewriteable non-volatile memory, include but are not limited to memory cards, and media with a built-in ROM, including but not limited to ROM cassettes, etc. Furthermore, various information regarding stored images, for example, property information, may be stored in any other form, or it may be provided in other ways.

The apparatuses and methods described in this application may be partially or fully implemented by a special purpose computer created by configuring a general-purpose computer to execute one or more particular functions embodied in computer programs. The functional blocks and flowchart elements described above serve as software specifications, which may be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language) or XML (extensible markup language), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Haskell, Go, SQL, R, Lisp, Java®, Fortran, Perl, Pascal, Curl, OCaml, Javascript®, HTML5, Ada, ASP (active server pages), PHP, Scala, Eiffel, Smalltalk, Erlang, Ruby, Flash®, Visual Basic®, Lua, and Python®.

What is claimed is:

1. A system for performing analysis of documents, wherein the system comprises:
a user interface configured to:
obtain a set of user-specific context parameters and one or more text documents from a user device, wherein the user-specific parameters relate to one or more queries on a set of information provided within the one or more text documents;
an interpretation module configured to:
determine the set of information from the one or more text documents based on the set of user-specific context parameters; and
generate a text summary for the set of information;
an extraction module configured to:
extract the set of information into a plurality of fields of a predefined data structure; and
the user interface configured to:
render the text summary for the set of information along with the predefined data structure on a display of the user device.

2. The system of claim 1, wherein the predefined data structure comprises one of a comma-separated values (.csv) file, and a tabular format in a textual document.

3. The system of claim 1, wherein the text document is in one of an image format, and a textual format.

4. The system of claim 3, wherein the interpretation module is further configured to:
convert the text document from an image format to a textual format; and
parse the text document to obtain a plurality of sets of information.

5. The system of claim 1, further comprising:
a database configured to storing the predefined data structure.

6. A method for providing summaries of documents, the method comprising:
obtaining, a set of user-specific context parameters and a text document from a user device, wherein the user-specific parameters relate to one or more queries on a set of information provided within the text document;
determining, based on the set of user-specific context parameters the set of information from the text document;
extracting, the set of information into a plurality of fields of a predefined data structure; and
generating a text summary for the set of information on the user device along with the predefined data structure.

7. The method of claim 6, wherein the predefined data structure comprises one of a comma-separated values (.csv) file, and a tabular format in a textual document.

8. The method of claim 6, wherein the text document is in one of an image format, and a textual format.

9. The method of claim 8, further comprising:
converting the text document from an image format to a textual format; and
parsing the text document to obtain a plurality of sets of information.

10. The method of claim 6, further comprising:
storing the predefined data structure in a database.
